(19) United States
(12) Patent Application Publication
(10) Pub. No.: US 2014/0004228 A1
(43) Pub. Date: Jan. 2, 2014

(54) DRINKING STRAW WITH ADDED SCENT AND/OR FLAVOR AND METHOD OF MANUFACTURING

(71) Applicant: Erik Lipson, Philadelphia, PA (US)

(72) Inventor: Erik Lipson, Philadelphia, PA (US)

(21) Appl. No.: 13/540,190

(22) Filed: Jul. 2, 2012

(51) Int. Cl. A47G 21/18; A23P 1/12

(52) U.S. Cl. 426/85; 426/390

(57) ABSTRACT

Plastic drinking straws formed by extrusion from a multi-head extruder have at least partial layers of plastic on their outer and/or inner diameters, with the layers formed of scented and/or flavored plastics. These straws are generally used by children and the scents or flavors add to their novelty. They may be imprinted with spiral patterns produced by rotating the extruding straws and passing them against a rotating print wheel having its rotational axis inclined to the path of the straws.

### CROSS-REFERENCE TO RELATED APPLICATIONS

This application claims priority of U.S. Provisional Patent Application 61/503,826 filed Jul. 1, 2011, the contents of which are incorporated herein by reference.

### BACKGROUND OF THE INVENTION

Low cost drinking straws are often produced by extrusion and may incorporate plastics of different colors or shades to produce patterns such as stripes. Typical extruded plastic drinking straws having “barber pole” type stripes are shown in my U.S. Pat. No. 7,661,945.

There exist commercially available plastic additives which can lend scent and/or flavor to plastics. For example, the PolyFlav product sold by Add the Flavor, LLC may be used. These are available as particles which may be added to the plastic resin pellets fed into extruders.

The appeal to children of incorporating appropriate flavoring and/or scent into their drinking straws is evident. However, a significant obstacle to the incorporation of these additives to many plastic products is represented by the relatively high cost of the additives. While adding scent-containing plastic to a relatively expensive article such as a piece of jewelry may not substantially impact the cost of the item, adding scent or flavoring to a very low cost article, such as a disposable plastic straw, would substantially impact the cost.

### SUMMARY OF THE INVENTION

The present invention is therefore directed toward a composite plastic article in which a portion provides the necessary structural properties for the article and another portion comprises the scented or flavored plastic which imparts the desired flavoring or scent to the entire article.

More particularly, the present invention relates to plastic straws which are formed by a coextrusion process in which a single extruding head is fed with the outputs of two or more extruders, one of which forms the basic body of the straw and one or more others form either or both thin interior or exterior coatings formed of the high cost scented or flavored plastic.

In a preferred embodiment of the invention the plastics forming the body may be of several different colors, necessitating the addition of more than two extruders to feed the extruding head. The extruding head may be rotated during the extrusion process in the manner illustrated in my U.S. Pat. No. 7,661,945 or other known sources to produce a spiral striped “barber pole” appearance to the finished product.

By use of these techniques only a small percentage by weight of the finished product must be formed of the scented or flavored material with the balance forming the structural properties for the straw.

### BRIEF DESCRIPTION OF THE DRAWINGS

Other objects, advantages, and applications of the present invention will be made clear by the following description of preferred embodiments. The description makes reference to the following drawings, in which:

FIG. 1 illustrates two packages of straws made in accordance with the present invention;

FIG. 2 is a cross section through one of the straws of FIG. 1;

FIG. 3 is a cross-sectional view of an alternative form of the invention in which the flavored or scented additive is included in a thin inner skin rather than in an outer skin as illustrated in FIG. 2;

FIG. 4 is a cross section of another embodiment of the invention having an outer skin formed of either a scented or flavored plastic and an outer skin formed of the other type of additive;

FIG. 5 is a cross section through a still another embodiment of the invention wherein the inner and outer walls are formed with flavored and scented plastic and extend over only a portion of the circumference of the middle plastic core;

FIGS. 6A and 6B relate to the method of manufacturing the straws of the previous drawings, illustrating a rotating printing head positioned to rotate in a path inclined to a rotating straw to produce a spiral print pattern;

FIG. 7 illustrates the orientation of the printer head shown in FIGS. 6A and 6B over the rotating straw; and

FIG. 8 illustrates an alternative design for the spiral printing apparatus which supports the straw on a counter-rotating bed.

### DETAILED DESCRIPTION OF THE PREFERRED EMBODIMENTS

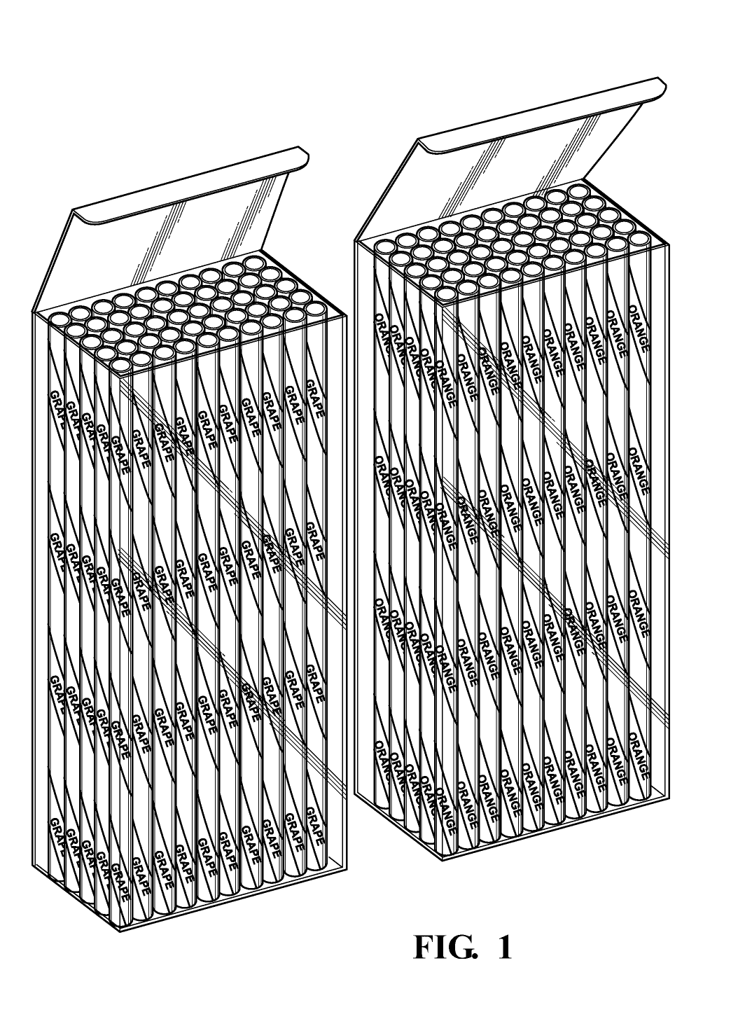

Referring to the attached drawings, FIG. 1 illustrates two packages of straws formed in accordance with the present invention. The orange straws on the left are imprinted with multiple occurrences of the word “orange” on a barber pole design of spiraling dark orange and light orange coloring. The straws may be either orange scented or orange flavored or both. Similarly, the purple straws on the right with the word “grape” repeatedly imprinted thereon may be either grape flavored, grape scented, or both.

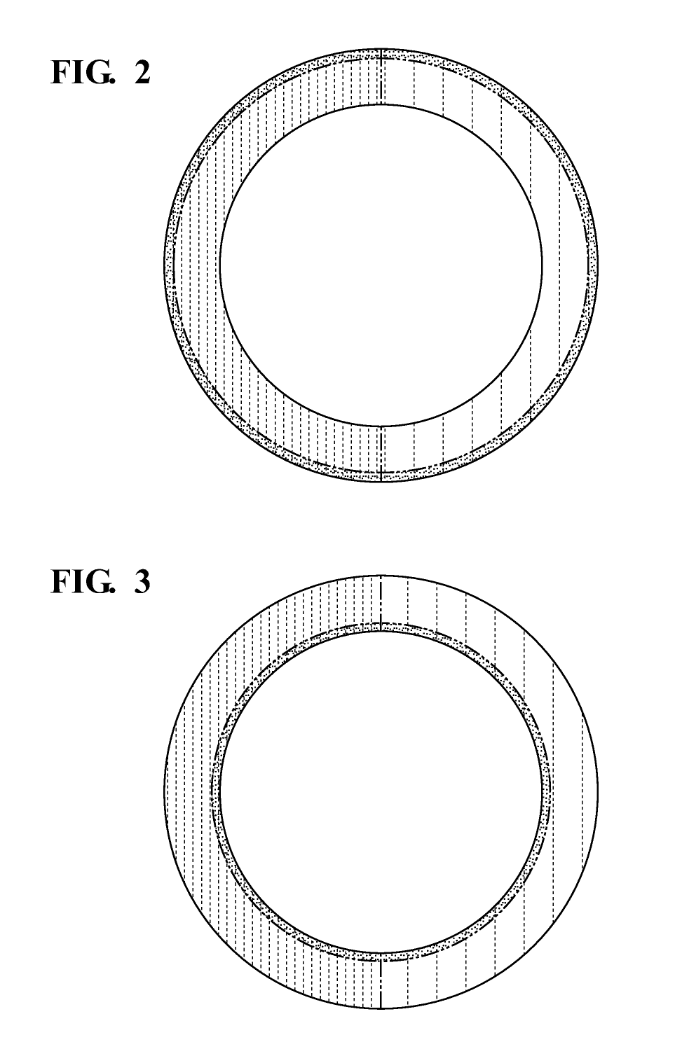

FIG. 2 illustrates a cross section through one of the purple straws and shows the relatively thin outer coextruded covering of the straw which is formed with plastic blended with either a grape flavor or scent. The outer skin matches the spiral color of the inner section. The physical properties of the straw are derived primarily from the inner section. These may include necessary flexibility or rigidity. The very thin outer skin layer comprises the plastic resin with the flavor or scent additive. This outer skin thus represents a small fraction of the bulk of the entire straw so that the material cost of the outer skin with its additives does not appreciably add to the cost of the entire straw. Were the straw to be made in one piece with the flavor and/or scent additive extending throughout the bulk of the straw, the manufacturing cost would be substantially higher than with the construction of the present invention.

FIG. 3 is a cross-sectional view of an alternative construction for the flavored or scented straw in which the flavor or scent additive is included in a thin inner skin rather than the outer skin. This will work better when the inner skin is a flavor additive, which will be added to the liquid as it is drawn through the straw, as opposed to a scent additive which will be somewhat attenuated by the relatively thick outer skin. Again, the structural properties are in the relatively thick outer layer to avoid the cost of using the plastic additive throughout a straw having dimensions which will provide the necessary structural properties.

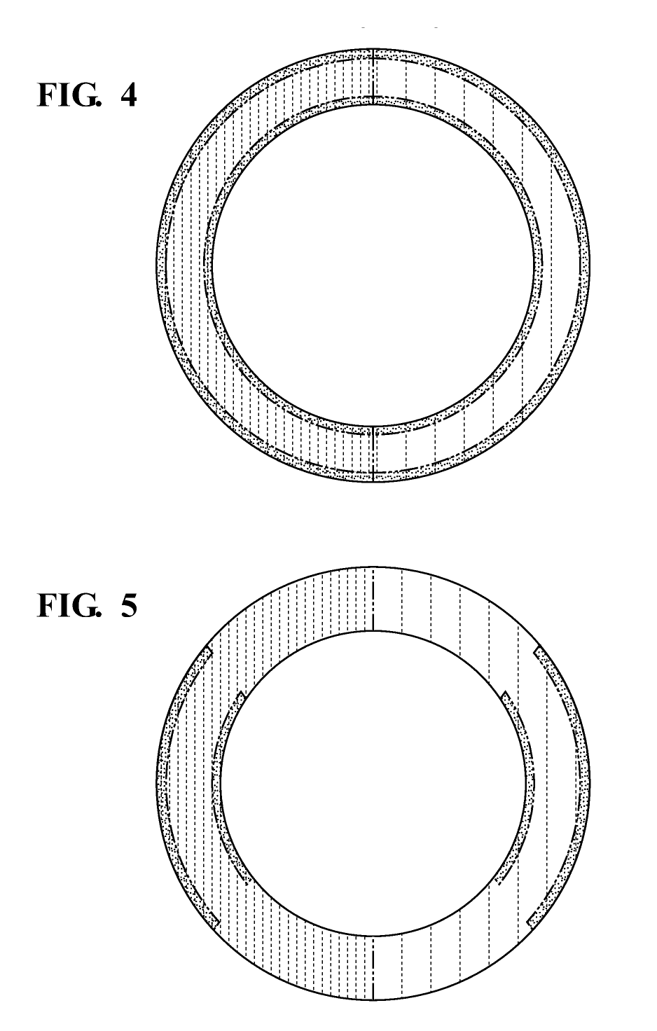

Referring to FIG. 4, an alternative embodiment of the flavored/scented straw is illustrated in cross section. This embodiment has both an outer skin and an inner skin. Preferably the scent additive will be contained within the relatively thin outer skin and the flavoring additive will be contained within the relatively thin inner skin, although this order may be reversed and/or both flavoring and scent additives may be incorporated in both layers. In the embodiment in which the scent additive is in the outer layer and the flavor additive is in the inner layer, the maximum advantage is taken of these additives.

FIG. 5 illustrates an embodiment of the invention in which the inner and outer walls containing the flavor and/or the scent additive extend over only a portion of the circumference of the structural middle layer. Only a single partial inner or outer layer might be employed in other embodiments.

While all of the illustrated embodiments show the central structural layer as having the same color as the additive containing inner and/or outer coatings, this is not a necessary feature and the central section may differ in color from the additive containing layers.

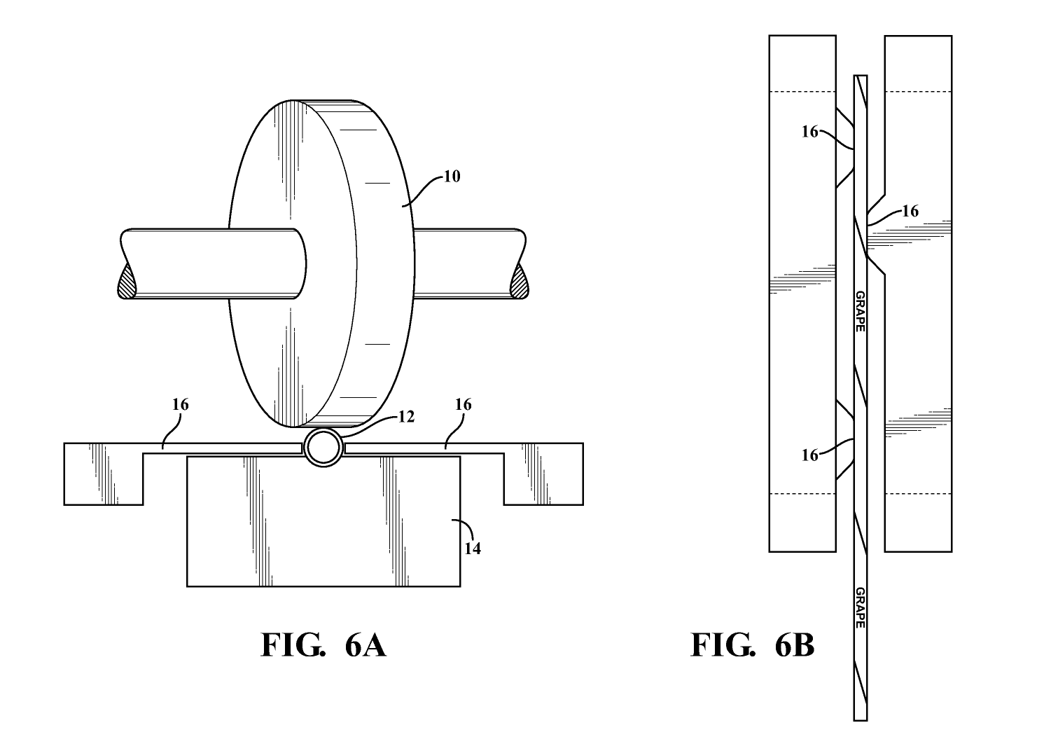

In manufacturing a straw with spiral stripes, the straw is usually rotated by a puller as it emerges from the extruder head. FIGS. 6, 7 and 8 schematically illustrate how an in-line printer having a rotating printer head may be used to print along the spiral as illustrated in FIG. 1.

FIG. 6A shows a rotating print head 10 which is positioned to rotate in a plane inclined to the path of the rotating straw 12, shown in end view. The straw advances over a bed 14 aligned by opposed side guides 16. FIG. 6B shows the top view of the straw path.

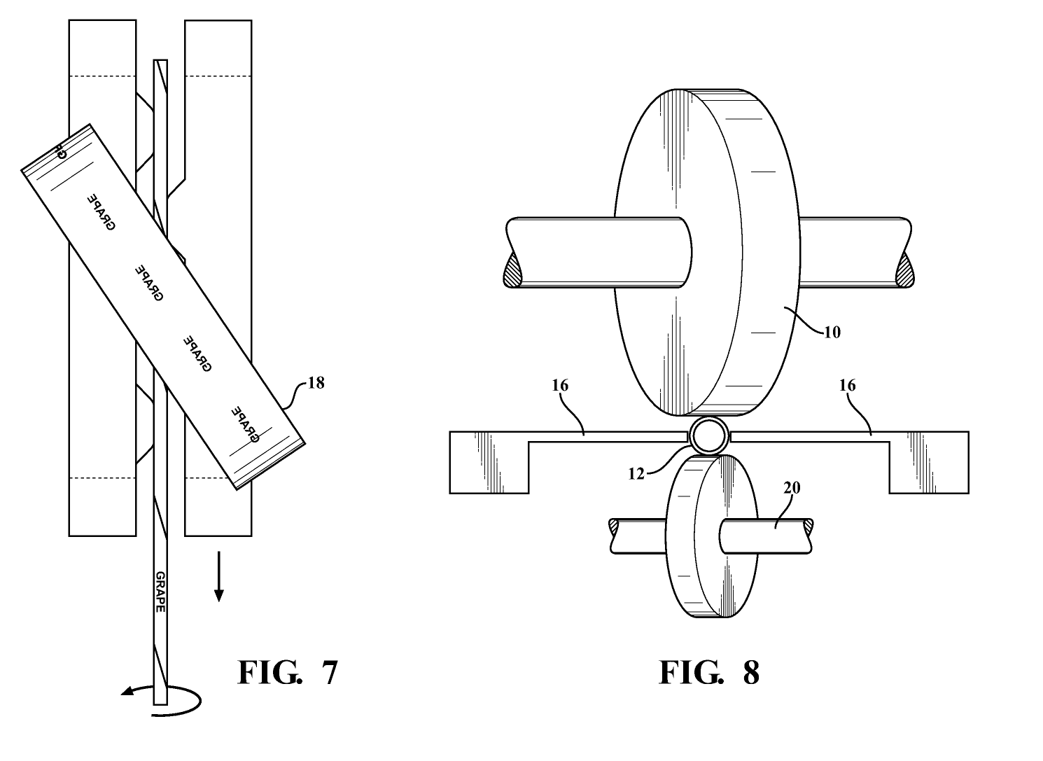

FIG. 7 illustrates the orientation of the rotating wheel printer head 18 over the straw.

FIG. 8 illustrates an alternate design which supports the straw, shown in end view by a counter-rotating wheel 20 rather than the bed 14.

While the present invention is illustrated in connection with a drinking straw, similar techniques could be used to form other articles.

The three embodiments of the invention which are illustrated can all be manufactured with coextrusion apparatus of the type shown in my U.S. Pat. No. 7,661,945 with an extrusion head directing the additive-enhanced plastic to either an inner or outer layer, or both. Alternatively, other known coextrusion apparatus could be used to form the present invention.

Having thus disclosed my invention, I claim:

1. (canceled)

2. The drinking straw of claim 10, wherein the layer extends only partially around the circumference of the central structural body.

3. The drinking straw of claim 10, wherein the tubular structural plastic body is round in cross section.

4. The drinking straw of claim 10, wherein the tubular structural plastic body is polygonal in cross section.

5.-9. (canceled)

10. A drinking straw comprising a tubular structural plastic body having a wall of a first thickness covered by a plastic layer of thickness less than the first thickness, said layer being selected from the group consisting of an inner layer and an outer layer, the straw being repeatedly imprinted along the outer side of its length with the name of a particular fruit and the layer being impregnated with an additive chosen from the group consisting of a scent of the particular fruit and a flavoring of the particular fruit.
